(19) United States
(12) Patent Application Publication
(10) Pub. No.: US 2002/0000300 A1
(43) Pub. Date: Jan. 3, 2002

(54) Device for splitting the ends of a fibre strand consisting of a bonded fibre material

(76) Inventor: Gregor Schwegler, Luzern (CH)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 09/933,537

(22) Filed: Aug. 20, 2001

(30) Foreign Application Priority Data
Feb. 23, 1999 (EP) 99810160.4
Feb. 18, 2000 (CH) PCT/CH00/00089

(51) Int. Cl. B32B 31/00

(52) U.S. Cl. 156/522

(57) ABSTRACT

A device for splitting the ends of strands of laminar bonded fiber material, preferably carbon fiber-reinforced lamellae, into two or more end piles with a cutter, accurately to the measurements. The device includes a positioning device which enables the cutter to be aligned exactly in relation to the end of the fiber strand. In one embodiment, the carbon fiber lamella is fixed on a bearing table in a cutting position and a cutter that is pivotally mounted on the table is manually pivoted through the lamella end. In another embodiment, the cutter is held in a cutter slide and can be linearly displaced together with the same along a slide guide. Yet another embodiment includes a planing device in which the cutter is fixed and placed on the lamella end, the lamella end being guided through a linear guide and onto the cutter directly at the front in a manner which is accurate to the measurements and split into the desired number of end piles.

### BACKGROUND OF THE INVENTION

The present invention relates to a device for splitting the ends of a lamella of fibre composite material, especially a carbon-fibre-reinforced plastics material lamella for reinforcing load-bearing structures, the device comprising a cutter.

Fibre composite materials have proved themselves for increasing the load-bearing capability of load-bearing structures at existing buildings, which materials, for example in the form of lamellae of carbon-fibre-reinforced plastics material, so-called CFRP lamellae, are glued under bias over an area on the tension side of the load-bearing structure. Of particular significance in that case is the introduction of the biasing force by way of closure elements to the CFRP lamella. The ends of the CFRP lamella are split into at least two end plies along the fibre direction and connected in force-locking manner with the closure element, preferably glued, as is illustrated in Swiss Patent Application No. 1997 1987/97, which is not prior disclosed. Due to the splitting, an advantageous increase in the gluing area is achieved without the strength properties of the CFRP lamella in tension direction being impaired.

Due to the small cross-sectional thickness of the lamella, what matters is maintaining the desired end ply thickness and avoiding separation through of the lamella. If in that case an end ply turns out to be too thin, then there is a great risk that the brittle fibres are bent over by the spreading apart of the end plies during mounting or during fixing in the connecting element at the structure and are no longer available for introduction of the biasing force by way of the connecting element into the lamella.

The invention present therefore has the object of indicating a device which enables a separating of the lamella ends in simple manner.

### SUMMARY OF THE INVENTION

The present invention concerns a positioning device for the lamella, at which device the cutter is fixed, serves for this purpose. In that case cutter and positioning device are fixed in their position relative to one another, so that the fibre strand is aligned or positioned in desired manner in its position relative to the cutter. The cutter can be placed precisely at the fibre strand end and thereby split up end plies with desired layer thickness in intended and reproducible manner. Due to the laminar structure the cutter penetrates through the cross-sectional width in fibre longitudinal direction into the fibre composite material and splits a layer of the fibres, which have tensile strength in the fibre direction but which are brittle, fixed in the matrix. The cut sharpness is therefore so selected that it penetrates only into the matrix of the lamella and does not cut through the individual fibres. In order to avoid, during the cutting process, a breaking off possibly of thin end plies, it is best to use a cutting blade with a thin back of a few millimeters.

According to a preferred embodiment of the invention the positioning device is formed as a support table with a flat support surface. In the region of the support surface a two-dimensional guide ensures that the lamella ends to be split are aligned in a desired cutting position relative to the cutter. The lamella brought into the cutting position is fixed in its position on the support table by means of a holding-down device. The cutter is, in common with a paring knife supporting it, connected with the support table to be pivotable about a pivot axis provided vertically relative to the support surface. In that case the paring knife bears by its planar underside on the support surface, whereby the cutter on pivotation of the paring knife in direction towards the lamella undergoes an exact guidance.

The guide ensures that on one hand the lamella is supported in the cutting/pivoting direction of the paring knife and on the other hand that end plies are split off or separated off with desired thickness. The latter is preferably settable by way of the support position of the lamella on the support surface. Thus, in one embodiment templates are used which for setting the end ply thickness predetermine the support level of the lamella on the support surface and, through these, place the cutter at the desired position at the lamella cross-section.

According to another embodiment it is advantageous with respect to a precise cut guidance if the cutter does not lie at the same time over the entire width at the end face of the lamella, but the position of the pivot axis in relation to the cut application is selected in such a manner that the cut is applied at one edge. The cut in that case penetrates effortlessly to the desired level and experiences a cut guidance during the further cut movement through the laminar structure of the lamella. According to another preferred embodiment of the invention the positioning device is in turn constructed as a support table for the lamella end to be split. As in the previously described embodiment, a lateral guide and a template for bedding the lamella serve the purpose of bringing the lamella into the desired cut position in which it is finally fixed by means of the pressing-down device.

However, the cutter is to be moved in translational manner onto the positioned lamella end. Here, too, the cutter bears on the support surface, but is held in a knife carriage and displaceable together with this along a carriage guide relative to the support table. The carriage guide comprises two guide rods, which are arranged parallel to the translational movement preferably laterally at the support table and at which the knife carriage is fixed to be axially displaceable. Due to this parallel guidance the cutter experiences a particularly precise guidance, for which reason this embodiment is suitable to a high degree for splitting off or separating off a greater number of and thinner end plies.

Knife carriage and carriage guide are constructed to be strong and rigid. Moreover, the cutter is arranged close to the support table and not laterally thereabove, whereby the risk of injury for the user as well as the risk of damage to the cutter are small. For the stated reasons this embodiment offers advantages in the mounting of the lamella at a building site.

In a further particularly preferred embodiment of the invention, a positioning device and cutter are fixedly interconnected to form a planing tool. The positioning device forms a guide for the lamella, by virtue of which this can be inserted exclusively in longitudinal direction onto the free end of the lamella and be displaced. In that case the guide is oriented in such a manner that the lamella end at the end face runs directly onto the cutter and is split up into end plies. This embodiment has a particularly simple and robust construction; it enables a splitting of the lamella end without previous clamping or fixing of the lamella to the positioning device and is thereby particularly simple in handling. Moreover, the cutter is embedded in the positioning device and accordingly protected against damage and does not represent a risk of injury for the user. By virtue of its compact construction the planing tool embodiment is particularly well suited for use at a building site, where each reinforcing lamella can thus be adapted to the respectively required dimensions and the connecting elements can be mounted.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 shows a paring knife as a first embodiment of the invention, in plan view;

FIG. 2 shows a schematic cross-sectional view of the paring knife along the section line II-II in FIG. 1;

FIG. 3 shows a schematic detail view III of FIG. 2;

FIG. 4 shows, schematically, a second embodiment of the invention with a cutter movable translationally;

FIG. 5 shows, schematically, a third embodiment of the invention;

FIG. 6 shows a half sectioned view of the embodiment illustrated in FIG. 5, along the section line VI-VI; and

FIG. 7 shows a cross-section through a reinforced concrete beam with a CFRP lamella mounted on the underside, with a schematic cross-section through a locking element of a CFRP lamella.

### DESCRIPTION OF THE PREFERRED EMBODIMENT

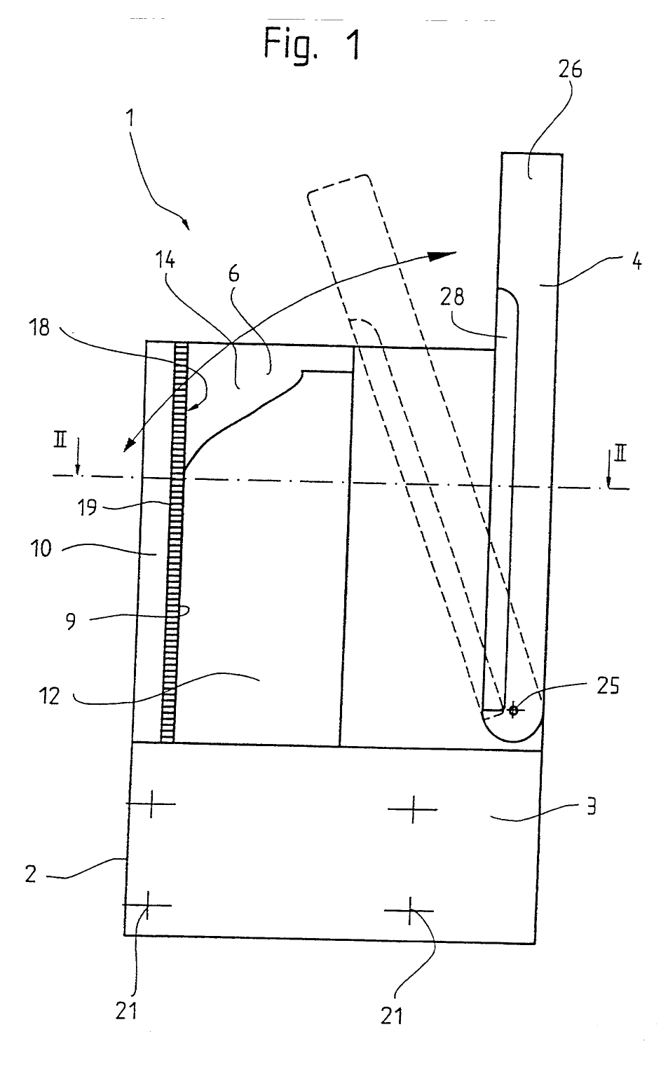

FIG. 1 shows a first embodiment of the device 1 according to the invention. The device 1 comprises, as essential subassemblies, a support table 2, a pressing-down device 3 and a paring knife 4 pivotably connected with the support table 2.

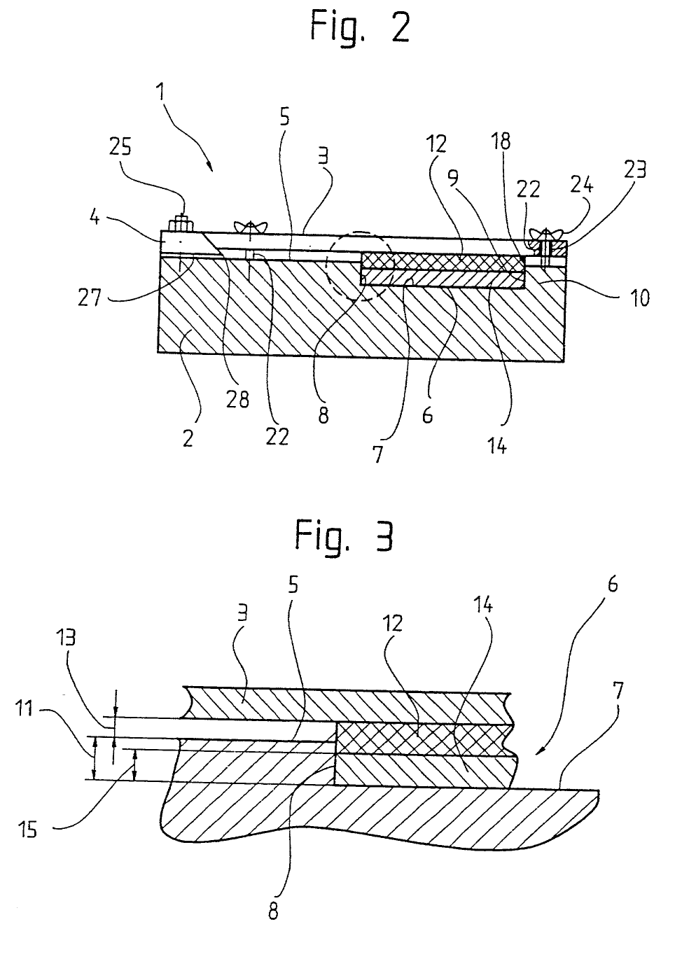

The support table 2 has a rectangular outline and a flat support surface 5. Machined over the entire length of the support table 2 on one half of the support surface 5 is a positioning groove 6, the U-shaped cross-section of which, as illustrated in FIG. 2, is bounded by a flat groove base 7, a first flank 8 and a second flank 9, which extends parallel thereto, of an abutment strip 10.

The groove depth 11 is oriented to the thickness of the lamella 12 to be split and the desired thickness 13 of the end plies to be split off or pared off. The groove depth 111 is usually selected in such a manner that the CFRP lamella 12 laid into the positioning groove 6 protrudes by the desired dimension of the end ply thickness 13 above the positioning groove 6. In order to be able to also set the thickness 13 of the end plies, which are to be split off, independently of the lamella thickness, a template 14 is additionally laid into the positioning groove 6 in the case of the embodiment illustrated in FIGS. 1 to 3. The CFRP lamella which bears on this template 14, can be bedded down above the thickness 15 thereof until the desired layer or end ply thickness 13 projects above the positioning groove 6, which can be clearly recognized in FIG. 3.

The width 16 of the positioning groove 6 is here selected to be slightly greater than the width of about 80 millimeters of a CFRP lamella 12, the end-face end 17 of which is to be split into end plies. Basically the positioning groove 6 is provided to be equal in width to or wider than the CFRP lamella 12, so that it is ensured in every case that the CFRP lamella 12 finds sufficient space in the positioning groove 6 and lies flatly on the groove base 7 or the template 14. Independently of the actual lamella width, the lamella 12 bears laterally against the abutment strip and is clamped down by means of a holding-down device 3 described further below and fixed in its position.

A scale calibration 19 is formed along the abutment edge 18 of the abutment strip 10 starting from the holding-down device 3. It serves the purpose of aligning the free end 17 of the CFRP lamella in the position groove 6 to the desired length of the end plies.

The holding-down device 3 bears by a flat pressing surface 20, which faces the support surface 5, on the CFRP lamella 12 and is screw-connected by four tightening screws 21 relative to the support surface 5. The screw bolts 22 are anchored in the support table 2 and project through the holding-down device 3 by way of four correspondingly arranged bores 23. A respective wing nut 24, which is supported on the holding-down device 3 and presses this down, is screwed onto the free end, which protrudes above the holding-down device 3, of each of the screw bolts 22. Other quick-action fastening means or devices are also possible instead of the tightening screws 21 with wing nuts 24.

Thus, the holding-down device 3 can be connected, for example, at one side by way of a hinge or the like with the support table 2 and the opposite side can be pressed down onto the CFRP lamella 12 by way of a quick-action closure or a quick-action clamping screw. A holding-down device which is foldable in this manner is particularly simple in use.

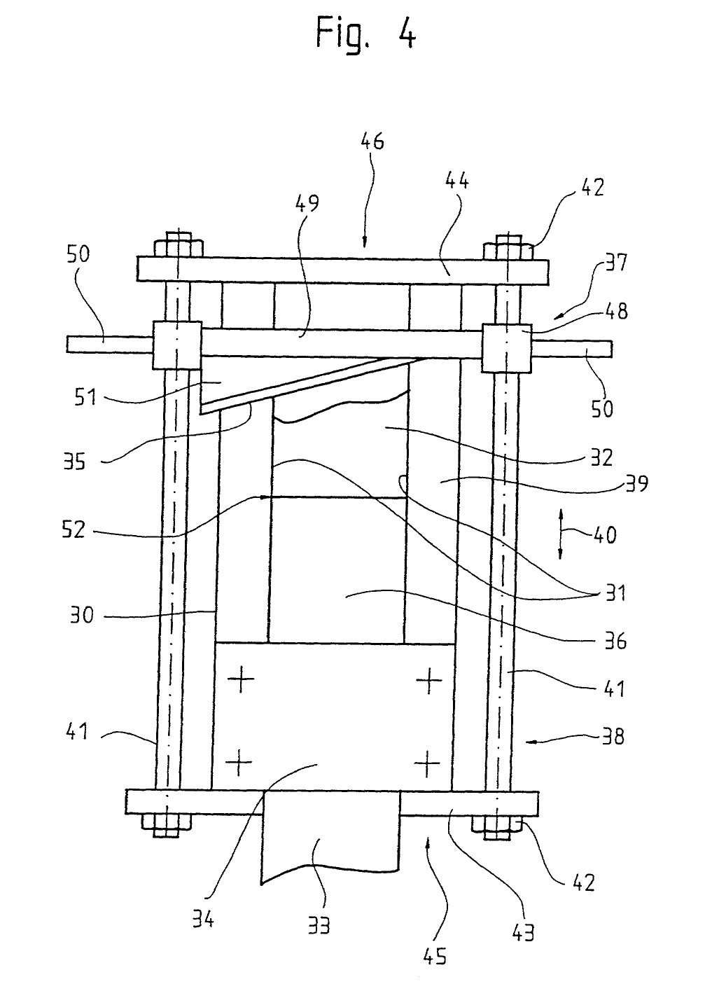

One end of a paring knife 4 is connected with the support table 2, on the side opposite the abutment strip 10, to be pivotable about a pivot axis 25 provided vertically relative to the support surface 5. The length of the paring knife 4 is so dimensioned that it protrudes by its other end, which is constructed as a handle 26, beyond the support table 2. With the exception of the handle 26, the side of the paring knife 4 facing the positioning groove 6 is obliquely sharpened and forms the cutter 28 by the underside 27 along the common edge. The underside 27 of the paring knife 4 is illustrated flat and bears on the support surface 5, whereby the cutter 28 then experiences a precise guidance on pivotation of the paring knife 4 about the pivot axis 25. The position of the pivot axis 25 and in addition the position of the cutter 28 relative to the positionally fixed CFRP lamella 12 is so selected that the cutter 28 pivoted by hand into the setting illustrated in chain-dotted lines in FIG. 1 hits at the corner edge 29 against the CFRP lamella 12 and can there apply the cut precisely at the level of the support surface 5. As soon as the cutter 28 has penetrated into the fibre strand laminate of the CFRP lamella 12 and the cut is placed, the paring knife 4 can be pivoted by hand until in its end position parallel to the holding-down device 3. In FIG. 4 there is illustrated a second embodiment of the invention in which in addition a support table 30 is provided, in which a lateral guide 31 and template 32 for bedding the CFRP lamella 33 serve the purpose of bringing the lamella 33 into a desired cut position in which it is finally fixed by means of the holding-down device 34. By contrast to the previous example the cutter 35 is here to be moved translationally onto the positioned lamella end 36.

The cutter 35 is held in a knife carriage 37 and displaceable together with this along a carriage guide 38 relative to the support table 30 on the support surface 39. The carriage guide 38 comprises two guide rods which are arranged parallelly to the translational direction 40 laterally at the support table 30 and are screw-connected at both ends by way of a screw connection 42 to two beams 43, 44. One beam 43 is fastened at the front side 45 and the beam 44 at the rear side 46 of the support table 30 by means of screw connections 47. The knife carriage 37 is fixed to this carriage guide 38, which is fixedly connected with the support table 30, to be axially displaceable.

The knife carriage 37 comprises two guide sleeves 48 which are plugged onto the guide rods 41 and surround these. The guide sleeves 48 are fixedly connected together by way of a cutter carrier 49. Arranged in notional prolongation of the cutter carrier 49 and at both sides are freely protruding rod-shaped handles 50 by which the inherently stiff knife carriage can be displaced by hand.

Instead of the handles 50 it is also possible to displace the knife carriage 37 by means of a lever or screw mechanism, which is not illustrated here in more detail. A lever mechanism can be pivotably connected to the guide sleeves 48, the tension force of which is introduced into the support table 30 by way of a correspondingly suitable kinematic system.

A blade 51 with a straight or, as illustrated here, obliquely extending cutting edge 35 is fixedly connected with the cutter carrier 49. Due to the oblique course of the cutting edge the cutter 35 initially hits against a corner edge 52 of the end-face lamella end 36. There the cutter 38 penetrates in punctiform manner into the fibre laminate and thus applies the cut. On further displacement of the knife carriage 37 the cutter 38 then splits or pares off the respectively desired laminate layer.

The knife carriage 37 and the blade 51 fastened thereto exhibit a cross-sectional profile which is wedge-shaped in cutting direction and which on penetration of the cutter 35 and progressing splitting of the lamella end serves as a guide step for the split-off laminate layer.

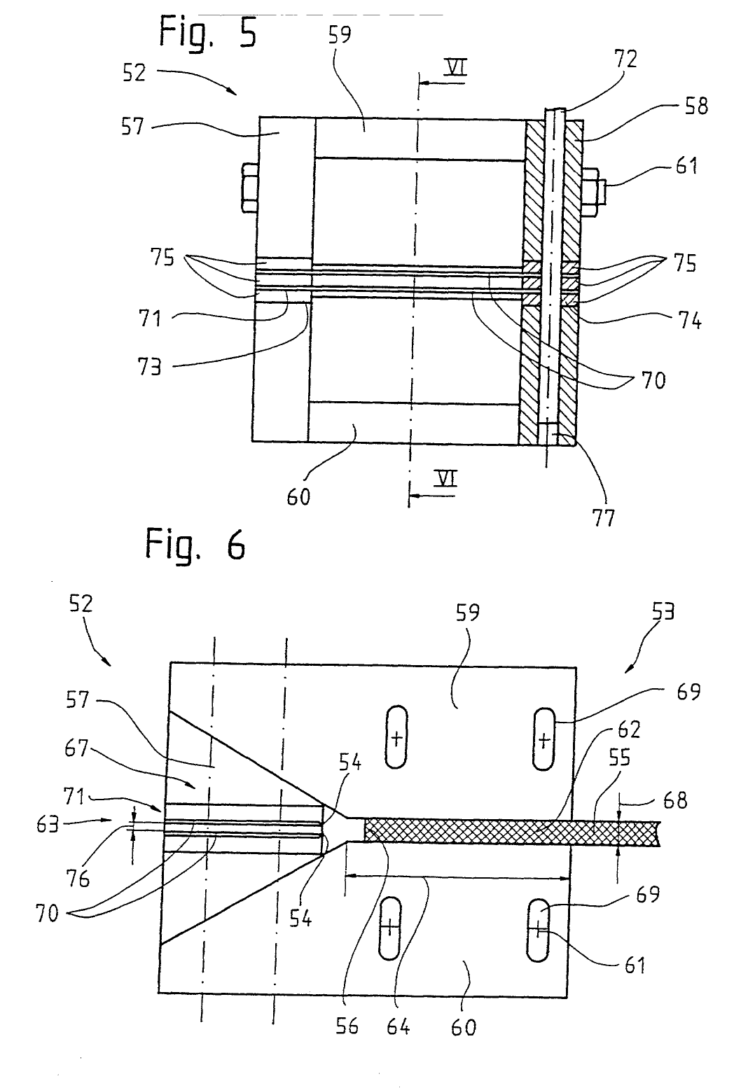

An embodiment of the device according to the invention in the form of a planing tool 52 is illustrated in FIGS. 5 and 6. The planing tool 52 differs from the previously described embodiments of the invention by cutters 54 fixedly anchored in a positioning device 53. With respect to the manner of function, the CFRP lamella 55 is not, in the case of this embodiment as a planing tool 52, fixed in cutting position on the positioning device 53, but cutters 54 and guide of the CFRP lamella 55 are fixed in their position relative to one another in constructionally defined manner and are displaced as a unitary device in common relative to the CFRP lamella 55. On displacement, the free lamella end 56 is split up in one working process into the desired number of end plies.

The planing tool 52 forms a first lateral part 57 and a second lateral part 58, between which a first guide block 59 and a second guide block 60 are fixedly clamped in place by means of four clamping screws 61. Lateral parts 57, 58 and guide blocks 59, 60 are preferably made of a metal material, such as aluminum; they can, however, also be made of plastic material or wood.

The first guide block 59 and the second guide block 60 bound therebetween in longitudinal direction of the planing tool a guide slot 62, which diverges in wedge shape towards the rear side 63. The guide slot 62 has a rectangular cross-section over a length 64 from the front side 65 up to the transition 66 to the wedge-shaped funnel 67, wherein the clear spacing 68 between the first guide block 59 and the second guide block 60 can be matched to the respective thickness of the lamella end 56, which is to be split, with the aid of elongate holes 69 formed in the two guide blocks 59, 60.

The width dimension of the guide slot 62 is constructionally fixed to one size; expediently, it is selected in every case to be larger than the lamella width. Two knife blades 70, which are axially aligned with the guide slot 62, project from the rear side 63 so far into the wedge-shaped funnel 67 that their cutting edges 62 reach up to the rectangular guide slot 62. The knife blades 70 extend over the entire width of the planing tool 52 and are combined in a knife insert 71 into a subassembly, which is fixedly mounted by means of socket pins 72 in the complementary recesses 73, 74 in the lateral parts 57, 58. The knife insert 71 comprises, apart from the two knife blades 70, on each side three spacers 75, by which the mutual spacing 76 of the knife blades 70 and thus the layer thickness of the end plies can be fixed. At the same time, by appropriate adaptation in thickness the position of each individual knife blade 70 and/or knife insert 71 can be aligned and set in relation to the guide slot 62.

For anchoring of the knife insert 71 two bores are provided on each side in the spacers 75 and knife blades 70 perpendicularly to the blade plane and one behind the other. The position of the bores corresponds with bores 77 in the lateral parts 57, 58, through which in the mounted state there is inserted the socket bolt 72 which fixes the knife insert 71.

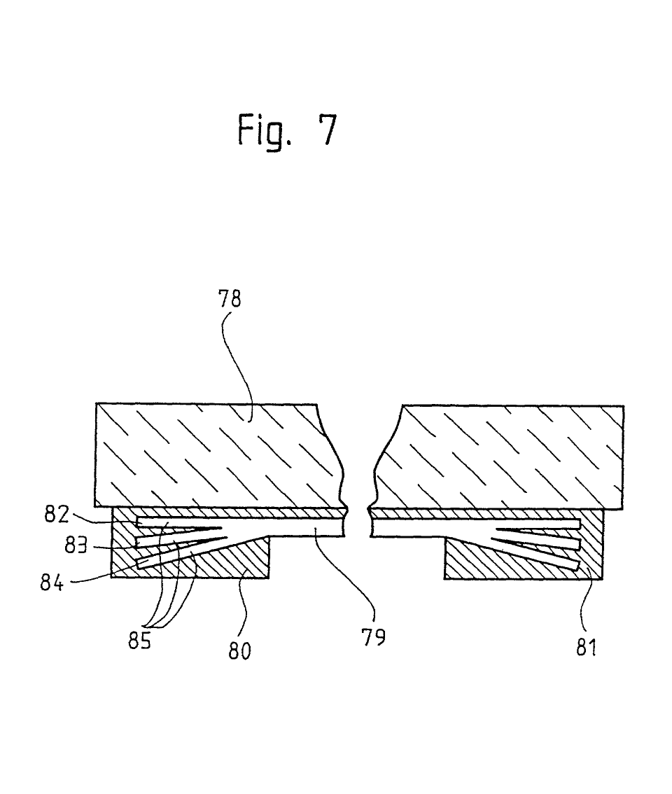

FIG. 7 shows a cross-section through a reinforced concrete beam 78 with a CFRP lamella 79, which is glued on at the underside (tension side) and at the ends of which closure elements 80 and 81 are mounted. Three retaining slots 82, 83, 84 are formed in the closure elements 80 and 81 to lie one above the other and to be spread apart in wedge shape, in each of which slots there is glued a respective one of three end plies 85, into which the end of the CFRP lamella 79 is split. The introduction of tension forces by way of the closure elements 80, 81 into the CFRP lamella 79 is thus improved.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. Device for splitting the ends of a lamella of fibre composite material into two or more end plies, comprising: a positioning device, which forms a support surface for the lamella of fibre composite material, and a cutter, which is fixed at a spacing substantially parallel to the support surface, wherein the spacing between the support surface and the cutter is smaller than the thickness of the lamella of fibre composite material.

2. The device according to claim 1 including an adjusting device is provided by means of which the spacing between the cutter and the support surface is adjustable.

3. The device according to claim 1 including a support table provided with an at least two-dimensional guide for the lamella of fibre composite material, by means of which the lamella of fibre composite material in its position relative to the cutter is oriented in a desired cutting position.

4. The device according to claim 1 wherein the lamella of fibre composite material in its position relative to the cutter is fixed to the positioning device by means of a clamping device.

5. The device according to claim 1 wherein the cutter is pivotably connected with the positioning device.

6. The device according to claim 1 wherein the cutter is connected with the positioning device for translational motion.

7. The device according to claim 1 wherein that the cutter is connected with the positioning device to be stationary during the splitting of the lamella of fibre composite material.

8. The device according to claim 7 including further cutters connected with the positioning device to be stationary.

9. The device according to claim 8 wherein the mutual spacing of the cutters relative to one another is adjustable.

10. The device according to claim 1 wherein the lamella of fibre composite material is a lamella of carbon-fibre-reinforced plastic material.
